(19) United States
(12) Patent Application Publication
(10) Pub. No.: US 2004/0213872 A1
(43) Pub. Date: Oct. 28, 2004

(54) Method for manufaturing animal food and plastic bag type air-tight fermentation container suitable for the same

(76) Inventors: Suk-Min Lee, Seoul (KR); Xian-ze Yu, Beijing (CN)

Correspondence Address: PLUMSEA LAW GROUP, LLC, 10411 MOTOR CITY DRIVE, SUITE 320, BETHESDA, MD, 20817, US

(21) Appl. No.: 10/481,609

(22) PCT Filed: May 10, 2002
(86) PCT No.: PCT/KR02/00873

(30) Foreign Application Priority Data
Jun. 22, 2001 (KR) 2001/35924

(51) Int. Cl. C12G 1/00

(52) U.S. Cl. 426/8

(57) ABSTRACT

A method for producing an animal feed has the steps of: cultivating funguses including actinomycess, deotrichum candidum, cellulose mono-saturated bacteria, lactic ferments, phycolmycete, protist, tirchoderma, saccharomyces cerevisiae, candida utilis, and aspergillus niger; producing fermenter by cultivating funguses to be fermented and then drying the cultivated funguses, and then by mixing the cultivated and dried funguses with sodium chloride, catalyzer and calcium oxide; mixing the produced fermenter with a raw material for the animal feed, the raw material being a mixture of one or more of grain, stem of field crop, power of plants, feces of livestock, waste of industrial ferments; and putting the mixture of the raw material and the fermenter in a sealed container, the sealed container being formed of different types of plastic film in multiple layers, and has a check valve formed on one side.

### FIELD OF THE INVENTION

The present invention relates to a method for producing animal feed and more particularly, to a method for producing animal feed by sealing a feed mixture with a microbial enzyme and water added in an air-tight plastic bag so that the contents can be fermented during storage or transport and an air-tight plastic bag suitable for the same.

### DESCRIPTION OF THE RELATED ART

For a long time, grain feed has been used as feed for animal. However, owing to lack of grain, the use of grain as material for feed has come to be difficult. The development of a substitute feed using various agricultural wastes attracts public attention.

Conventional methods for producing a substitute feed generally is performed by mixing a feed mixture of grains, stems of crops, grass powder, excrement of domestic animals, industrial fermentation waste and the like with a fermentation agent composed of various bacteria and fermentation promoters and water, and aerobically or anaerobically fermenting the resulting mixture in a fermentor, metallic container or hermetically sealed space or open space to produce a substitute feed. However, such conventional production methods have difficulties in storing and transporting the final feed obtained from the fermentation. In the feed a large amount of water and nutritive substances are contained, which contributes to make a condition under which decomposition bacteria are apt to propagate. Therefore, the feed can be readily denatured upon exposure to the air after opening. In case when the feed which is still wet after production is supplied to cattle, the feed should be fed to cattle in a short time right after exposure to the air, before it is denatured. Thus, using such feed can be used only in cattle breeding farms located near a place where the feed is produced. Otherwise, the feed should be further subjected to a drying process to reduce the water content and packed in a container so that the propagation of bacteria is prevented while storing and transporting for a long distance. However, during the drying process, various useful bacteria and nutritive substances produced from the fermentation by microorganisms may be lost, causing reduction in the effect of the feed when supplied to the animals. Also, lots of expenses are required for set-up and operation of the drying facility. Accordingly, the conventional methods for producing such recycled feed are recognized to have problems in that: they need a large scale equipment for fermentation, storage and transportation of the fermentation mixture obtained by mixing feed material with a fermentation agent, which incurs a large production expenses; the effect of feeding is decreased due to the loss of nutrients during the drying process; and the feed has limits in terms of transport distance and time, when it is used while still containing water.

### DISCLOSURE OF THE INVENTION

Therefore, in order to solve the problems involved in the prior arts; it is an object of the present invention to provide a novel method for producing feed, in which a fermentation mixture is fermented in a container which has functions as a container for fermentation and a container for packaging and transportation of the feed, whereby the fermentation mixture with water contained can be transported and sold to a user, and fed to animals while containing water but capable of being stored for a long period of time, without any additional process such as a drying process before packaging.

Also, a further object of the present invention is to provide an air-tight plastic container for fermentation and transportation of a feed mixture which is formed of a plastic film material having a multi-layer structure composed of different materials and is provided with a check valve at one side thereof.

In order to accomplish the above objects of the present invention, the method for producing animal feed according to the present invention comprises steps of culturing bacteria including actinomycess, Deotrichum candidum, cellulose mono-staturated (saturated?) vacteria (bacteria?), lactic ferments (lactic acid bacteria?), phycolnycete (phycomycete?), protista, tirchoderma, Saccharomyces cerevisiae, Candida utilis, Aspergillus niger to a level of at least 10¹⁰ bacteria per 1 g of bacteria mixture; drying the bacteria for fermentation and mixing them with sodium chloride, a catalyst and calcium oxide to form a fermentation agent; mixing feed material comprising grains, stems of crops, grass powder, excrement of domestic animals, industrial fermentation waste and the like with the fermentation agent; and sealing the resulting mixture of the feed material and the fermentation agent in an air-tight plastic bag provided with a check valve.

In the method for producing animal feed according to the resent invention, the mixture of the feed material and the fermentation agent sealed in the air-tight plastic bag is preferably fermented at a temperature of 5° C. to 40° C. for 10 days to 20 days.

Also, in another aspect of the present invention, there is provided a container for fermentation of animal feed comprising an air-tight plastic bag formed of a plastic film material having a multi-layer structure composed of different materials which is adapted to receive the mixture of the feed material and the fermentation agent prepared by the method according to the present therein and is provided with a check valve at one side thereof.

### DESCRIPTION OF THE DRAWINGS

FIG. 1 is a front view of the container for fermentation of animal feed used according to the present invention; and

FIG. 2 is a cross-sectional view of the container for fermentation of animal feed used according to the present invention taken from the line A-A in FIG. 1.

### BEST MODE OF THE INVENTION

Now, a preferred embodiment of the present invention will be described in detail with reference to the accompanying drawings.

In the explanation of the embodiment, the percents and rates are based on weight, unless specified otherwise. Firstly, bacteria used in a fermentation agent according to the present invention include any one or more selected from procaryotes, eucaryote and fingi. The prokaryotic bacteria include actinomycess, cellulose mono-staturated vacteria, lactic ferments and the like. Also, the eucaryotic bacteria include phycolmycete and protista. The fungi include tirchoderma, Saccharomyces cerevisiae, Candida utilis, Deotrichum cadidum, Aspergillus niger and the like. The above described bacteria are cultured according to a well-known method. The number of bactria obtained by the fermentation is preferably at least 10¹⁰ per 1 g of the bacteria mixture so that the bacteria culture can act as fermentation bacteria. After completing the cultivation as described above, the fermentation bacteria are dried and mixed with a fermentation promoter such as sodium chloride, a catalyst and calcium oxide to form a fermentation agent. The resulting fermentation agent is put in a container. Water is added thereto while well stirring and left for 10 minutes.

Then, the fermentation agent is scattered over feed material selected from pulverized grains, stems of crops, grass powder (length: 0.5 mm or less), dried excrement of domestic animals, industrial fermentation waste and a mixture of two or more thereof and the feed material is thoroughly mixed with the fermentation agent while adding water to produce a fermentation mixture. At this time, the fermentation mixture is examined for its condition and water or dry material may be added to adjust its water content to 70%. The added amount of the fermentation agent in the fermentation mixture is preferably about 1 to 1.5 wt % based on the weight of the dry material.

Now, the present invention will be explained in more detail using the following examples.

### EXAMPLE 1

Preparation of Fermentation Mixture

1 Kg of a fermentation agent was added to 230 Kg of water and stirred. To the resulting well-stirred solution of the fermentation agent, 1000 kg of a mixture of grains, stems of crops and grass powder was slowly added and stirred so that the components would be homogeneously mixed with each other. When the resulting mixture was massed into a lump and squeezed in one's hand as hard as one can, if water flowed out between fingers, it was the best condition for the preparation of a fermentation mixture (a water content of 40% to 70%, preferably about 50%). Water or dry powder may be added or reduced to accomplish such condition.

### EXAMPLE 2

Preparation of Fermentation Mixture

1 Kg of a fermentation agent was added to 230 Kg of water and well stirred. To the resulting well-stirred solution of the fermentation agent, 500 kg of a mixture of grains, stems of crops and grass powder and 500 Kg of excrement of domestic animals or industrial fermentation waste were slowly added and stirred so that the components would be homogeneously mixed with each other. When the resulting mixture was massed into a lump and squeezed in one's hand as hard as one can, if water flowed out between fingers, it was the best condition for the preparation of a fermentation mixture (a water content of 40% to 70%, preferably about 50%). Water or dry powder may be added or reduced to accomplish such condition.

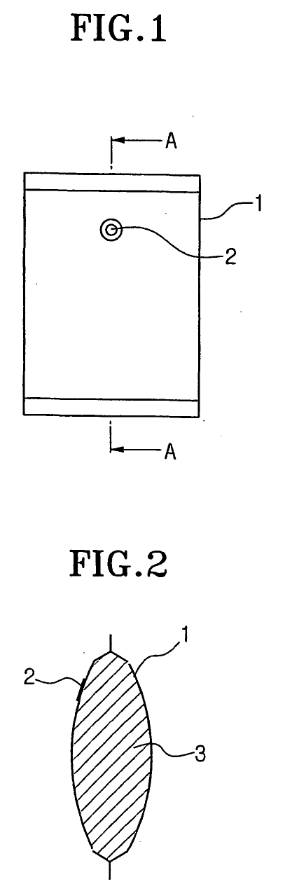

The fermentation mixture 3 prepared as described above was sealed in an air-tight plastic bag 1 provided with a check valve 2, as shown in FIG. 1 and fermented at a temperature of 5° C. to 40° C. for 10 to 20 days. The optimum temperature for fermentation is 35° C. Here, the sealed plastic bag may be put and sealed again in a packaging bag comprising one or two or more materials selected from kraft paper, plastic film, pp woven bag and the like to reinforce the strength to an external impact and damage.

As shown in FIG. 1, the plastic bag 1 used as a fermentor in the present invention, is provided with the check valve 2 at one side thereof. The check valve 3 serves to discharge gas within the plastic bag 1 but prevents the external air from entering the plastic bag 1. Accordingly, a large amount of gas generated by metabolism of microorganisms during the fermentation may be discharged to the air through the check valve 2, whereby the plastic bag can be protected from any damage such as explosion caused by increase of the inside pressure and impact from the outside while maintaining its air-tight state. Also, the check valve serves to provide a propagation environment of useful microorganisms to the fermentation mixture 3 in the plastic bag 13 by preventing the contaminated air of the outside from entering the plastic bag 2. Therefore, it is possible to store a feed after completion of fermentation for a long period of time.

Further, in conventional methods for producing animal feed, when raw material is supplied in a large amount to a large-sized container or fermentor used for fermention, the upper part and the lower part may show a great difference in their water contents (the water content of the upper part is lower than that of the lower part), since added water is pulled downward by gravity. For such fermentor, an additional stirring device is generally provided. Accordingly, it is recognized that the conventional fermentation methods have a problem in quality control of fermentaion product in a large-sized fermentor. To the contrary, according to the present invention, since a plastic bag capable of holding 20 to 50 Kg is used as a container for fermentation, the water content of the fermentation mixture can be readily controlled.

The plastic bag 1 used in the present invention also serves as a container for packaging a product. Therefore, according to the present invention, the fermentation mixture 3 can be transported and fed to cattle while it is still wet, whereas conventional fermented feed is subjected to a drying process for prevention of decay after completion of fermentation. Thus, it is possible to prevent reduction of active microorganisms and loss of nutritive substances and metabolic substances of microorganisms that occur during drying of the fermentation feed.

In the course of fermentation, as the temperature is increased, various microorganisms are activated and work layer after layer to produce metabolic substances in a large amount. For example, the protease, cellulase and amylase decompose organic and inorganic substances to produce various nutritive substances. Also, by the fermentation, antibiotic substances and growth promoting substances are produced and digestive efficiency of crop feed is increased. Feed after fermentation has a sour taste and smells of ethanol and fish meal which suits animals' taste.

In the method according to the present invention, the fermentation time is not strictly limited. Typically, the fermentation time is short when the temperature is high, while the fementation time is long when the temperature is low. According to experiments, it takes about 48 hours of the shortest time to 3 months of the longest time, depending on the fermentation temperature, until animal feed is fermented sufficiently. The fermentation temperature according to the present invention is suitably about 35° C. Thus, the fermentation effect can be sufficiently obtained only by keeping the feed at room temperature depending on a region of production.

In addition, according to the present invention, the feed is prevented from being exposed to the air by means of the plastic bag 1 which is used as a container for both fermentation and packaging. A large amount of acid generated by fermentation metabolism of microorganisms contributes to inhibit propagation of decomposition bacteria by increasing acidity of the fermentation mixture in the bag. Accordingly, the feed can be preserved for at least 12 months while the container is not opened.

In the present invention, the fermentation mixture is contained and sealed in a air-tight plastic bag, which is also used as a packaging container for sale, provided with a check valve, it can be fermented during storage in a storehouse of manufacturer, during transportation to a distributor and storage in a storehouse of the distributor and during storage in a storehouse of a consumers.

The method for producing animal feed according to the present invention provides the following effects. Firstly, the conventional method for producing feed costs a great deal for equipments such as a fermentor or a metallic container for fermentation and drying means and management thereof, manpower and use of energy. However, in the present invention, since an air-tight plastic bag is used as a container for fermentation, the anaerobic fermentation of feed is performed during storage or transportation while packed in the bag without needing a separate fermentation means, whereby investment in equipment and manpower can be greatly reduced. Also, the method according to the present invention is advantageous in that the feed can be produced using readily available materials such as grains, stems of crops, grass powder, excrement of domestic animals, industrial fermentation waste and the like at a low coast. Also, according to the present invention, since a plastic-bag for product packaging is used as a container for fermentation, a large amount of gas generated by the metabolism of microorganisms during fermentation can be discharged through a check valve and thus, an air-tightly sealed state of the plastic bag can be kept against external impact and pressure. Also, it is possible to prevent the contaminated air of the outside from entering the plastic bag to maintain the environment suitable for the propagation of useful microorganisms in the container and thereby, to preserve the feed after completion of fermentation for a long period of time. Further, in the convention wet-type method for producing feed, it is difficult to control the water content in a large-sized container or fermentor in which water is distributed differently in the upper side and the lower side of the container by gravity during the fermentation. However, since the present invention uses a small-sized plastic sealed bag, control of water content can be readily accomplished. In addition, the plastic bag used in the present invention serves as a container for product packaging as well as a container for fermentation. Therefore, the feed can be directly supplied to animals while wet, without an additional drying process, whereby reduction of active beneficial bacteria and loss of nutritious substances and metabolic substances of microorganisms that occur during drying of the fermentation feed can be prevented and consequently, the effect feed on cattle is increased.

What is claimed is:

1. A method for producing animal feed comprising steps of:
culturing bacteria including actinomycess, Deotrichum candidum, cellulose monosaturated bacteria, lactic ferments, phycolmycete, protista, tirchoderma, Saccharomyces cerevisiae, Candida utilis, Aspergillus niger;
drying the cultured bacteria for fermentation and mixing them with sodium chloride, a catalyst and calcium oxide to form a fermentation agent;
mixing feed material comprising any one selected from grains, stems of crops, grass powder, excrement of domestic animals, industrial fermentation waste and a mixture of two or more thereof with the fermentation agent; and
sealing the resulting mixture of the feed material and the fermentation agent in an air-tight plastic bag provided with a check valve.

2. The method of claim 1, wherein the mixture of the feed material and the fermentation agent sealed in the air-tight plastic bag is fermented at a temperature of 5° C. to 40° C. for 10 days to 20 days.

3. A container for fermentation comprising an air-tight bag which is adapted to receive a mixture of feed material and a fermentation agent therein and is provided with a check valve at one side thereof.

4. The container of claim 3, wherein the air-tight bag is formed of plastic film material having a multi-layer structure of different materials.
